(19) United States
(12) Patent Application Publication
(10) Pub. No.: US 2005/0288026 A1
(43) Pub. Date: Dec. 29, 2005

(54) System and method for supporting soft handover in broadband wireless access communication system

(75) Inventors: Myung-Kwang Byun, Suwon-si (KR); Seung-Joo Maeng, Seongnam-si (KR); Jae-Ho Jeon, Seongnam-si (KR); Jeong-Heon Kim, Seoul (KR); Ji-Ho Jang, Seoul (KR); Pan-Yuh Joo, Yongin-si (KR); Jae-Weon Cho, Suwon-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/149,696

(22) Filed: Jun. 10, 2005

(30) Foreign Application Priority Data
Jun. 10, 2004 (KR) 2004-42763

(51) Int. Cl. H04Q 7/20

(52) U.S. Cl. 455/442

(57) ABSTRACT

Disclosed is a method for supporting a serving BS currently providing an MS with a communication service to perform handover in a broadband wireless access communication system which includes the MS, the serving BS and a target BS to which handover of the MS is directed. In such a method, the serving BS allocates the same sub-channel as that allocated to the MS in a specific time period by the target BS in the same time period, and information about the allocated sub-channel is transmitted to the MS.

### PRIORITY

This application claims priority to applications entitled “System and Method for Supporting Soft Handover in Broadband Wireless Access Communication System” filed with the Korean Intellectual Property Office on Jun. 10, 2004 and assigned Serial No. 2004-42763, the contents of which are hereby incorporated by reference.

### BACKGROUND OF THE INVENTION

b 1. Field of the Invention

The present invention relates to a system and a method for performing a handover in a broadband wireless access communication system, and more particularly to a system and a method for supporting soft handover in a broadband wireless access communication system employing an orthogonal frequency division multiple access scheme.

2. Description of the Related Art

In general, a mobile communication system using a cellular communication scheme is cited as a typical wireless communication system. In such a mobile communication system, Time Division Multiple Access (TDMA) and Code Division Multiple Access (CDMA) schemes are the typical multiple access schemes. With the rapid progress of technology, the CDMA system which mainly provides speech communication is developing into a system capable of high-speed packet data transmission.

However, the CDMA scheme experiences problems when attempting to transmit large amounts of multimedia data because its resources, that is, codes, reach the limit of use. Therefore, in order to divide more users and transmit more data to the divided users, a broadband wireless access communication system employing an Orthogonal Frequency Division Multiple Access (hereinafter referred to as “OFDMA”) scheme is gathering strength. The OFDMA scheme is a wireless access communication scheme which uses a plurality of sub-carriers that retain orthogonality or a sub-channel including at least such a sub-carrier for high-speed data transmission/reception.

Systems designed under the IEEE (Institute of Electrical and Electronics Engineers) 802.16e standard belong to a wireless access communication system based on the OFDMA scheme. The IEEE 802.16e communication system is a system which takes into consideration the mobility of a Mobile Station (hereinafter referred to as ‘MS’). In other words, handover must be provided so as to maintain uninterrupted communication wherever the mobile station moves.

Handover is a procedure which enables an MS to maintain uninterrupted communication while moving from one Base Station (hereinafter referred to as ‘BS’) to another BS. Such a handover may be divided into three types, including hard handover, soft handover and softer handover.

The hard handover interrupts a channel of a serving BS in communication with the MS and establishes connection to a channel of a target BS to which handover is directed as soon as possible, thereby providing continuity of communication. The soft handover maintains a channel of a serving BS in communication with the MS and a channel of a target BS to which handover is directed together and then releases the channel of the serving BS after the MS completely moves to a region of the target BS. The softer handover is basically the same handover scheme as the soft handover, except that it is applied when an MS moves not between BSs, but from one sector to another sector in a multi-sector base station.

As stated above, the handover scheme may be classified into the hard handover, the soft handover and the softer handover. Nevertheless, according to the specifications of the IEEE 802.16e, a standard for a broadband wireless access communication system, only the hard handover scheme can be supported. The hard handover has a disadvantage in that a signal may be disconnected. Although the disconnection of a signal occurs during a very short period of time, it may become a fatal drawback in the broadband wireless communication system which aims at stable transmission/reception of high-speed data. Accordingly, there is need for a scheme which can perform soft/softer handover from a cell or sector in which an MS is currently located to another cell or sector in an IEEE 802.16e communication system.

### SUMMARY OF THE INVENTION

Accordingly, the present invention has been made to solve at least the above-mentioned problems occurring in the prior art, and an object of the present invention is to provide a system and a method for allocating resources in order to support soft/softer handover in a broadband wireless access communication system.

A further object of the present invention is to provide a system and a method for efficiently transmitting/receiving data over an uplink and a downlink in a broadband wireless access communication system.

In order to accomplish these objects, in accordance with a method for supporting a serving base station (BS) currently providing a mobile station (MS) with a communication service to perform a handover in a broadband wireless access communication system which includes the MS, the serving BS and a target BS to which handover of the MS is directed. The method comprises the steps of allowing one of the serving BS and the target BS to allocate the same sub-channel as that which is allocated by the other BS to the MS in a specific time period in the same time period; and transmitting information about the allocated sub-channel to the MS.

In order to accomplish the above-mentioned objects, in accordance with a second aspect of the present invention, there is provided a method for supporting a serving base station (BS) currently providing a mobile station (MS) with a communication service to perform a handover in a broadband wireless access communication system which includes the MS, the serving BS and a target BS to which handover of the MS is directed. The method comprises the steps of allowing one of the serving BS and the target BS to allocate a different sub-channel from that which is allocated by the other BS to the MS in a specific time period in the same specific time period; and transmitting information about the allocated sub-channel to the MS.

In order to accomplish the above-mentioned objects, in accordance with a third aspect of the present invention, there is provided a method for supporting a serving base station (BS) currently providing a mobile station (MS) with a communication service to perform a handover in a broadband wireless access communication system which includes the MS, the serving BS and a target BS to which handover of the MS is directed. The method comprises the steps of: allowing one of the serving BS and the target BS to allocate a different sub-channel from that which is allocated by the other BS to the MS in a specific time period in a different time period; and transmitting information about the allocated sub-channel to the MS.

In order to accomplish the above-mentioned objects, in accordance with a fourth aspect of the present invention, there is provided a method for transmitting a signal by an MS in order to perform a handover in a broadband wireless access communication system which includes the MS, a serving BS currently providing the MS with a communication service and a target BS to which handover of the MS is directed. The method comprises the steps of receiving information about sub-channel allocation of the serving BS and information about sub-channel allocation of the target BS from at least one of the serving BS and the target BS; and transmitting the signal to the serving BS and the target BS using the allocated sub-channel corresponding to the information about sub-channel allocation.

In order to accomplish the above-mentioned objects, in accordance with another aspect of the present invention, there is provided a system for supporting handover in a broadband wireless access communication system. The system comprises a mobile station (MS); a serving base station (BS) which currently provides a communication service to the MS; and a target BS to which handover of the MS is directed, wherein one of the serving BS and the target BS allocates the same sub-channel as that which is allocated by the other BS to the MS in a specific time period in the same time period and at least one of the serving BS and the target BS transmits information about the allocated sub-channel to the MS, and wherein the MS receives the information about the allocated sub-channel and transmits a signal to the serving BS and the target BS using the allocated sub-channel corresponding to the information about the allocated sub-channel.

In order to accomplish the above-mentioned objects, in accordance with another aspect of the present invention, there is provided a system for supporting handover in a broadband wireless access communication system. The system comprises a mobile station (MS); a serving base station (BS) which currently provides a communication service to the MS; and a target BS to which handover of the MS is directed, wherein one of the serving BS and the target BS allocates the different sub-channel as that which is allocated by the other BS to the MS in a specific time period in the same time period and at least one of the serving BS and the target_BS transmits information about the allocated sub-channel to the MS, and wherein the MS receives the information about the allocated sub-channel and transmits a signal to the serving BS and the target BS using the allocated sub-channel corresponding to the information about the allocated sub-channel.

In order to accomplish the above-mentioned objects, in accordance with another aspect of the present invention, there is provided a system for supporting handover in a broadband wireless access communication system. The system comprises a mobile station (MS); a serving base station (BS) which currently provides a communication service to the MS; and a target BS to which handover of the MS is directed, wherein one of the serving BS and the target BS allocates the different sub-channel as that which is allocated by the other BS to the MS in a specific time period in the different time period and at least one of the serving BS and the target BS transmits information about the allocated sub-channel to the MS, and wherein the MS receives the information about the allocated sub-channel and transmits a signal to the serving BS and the target BS using the allocated sub-channel corresponding to the information about the allocated sub-channel.

In order to accomplish the above-mentioned objects, in accordance with another aspect of the present invention, there is provided a method for transmitting a signal by an BS in order to perform a handover in a broadband wireless access communication system which includes the MS, a serving BS currently providing the MS with a communication service and a target BS to which handover of the MS is directed. The method comprises the steps of receiving information about sub-channel allocation of the serving BS and information about sub-channel allocation of the target BS from at least one of the serving BS and the target BS; and transmitting the signal to the MS using the allocated sub-channel corresponding to the information about sub-channel allocation.

In order to accomplish the above-mentioned objects, in accordance with another aspect of the present invention, there is provided a system for supporting handover in a broadband wireless access communication system. The system comprises a mobile station (MS); a serving base station (BS) which currently provides a communication_service to the MS; and a target BS to which handover of the MS is directed, wherein one of the serving BS and the target BS allocates the same sub-channel as that which is allocated by the other BS to the MS in a specific time period in the same time period and at least one of the serving BS and the target BS transmits information about the allocated sub-channel to the MS, and wherein the MS receives the information about the allocated sub-channel and the serving BS and the target BS transmit a signal to the MS using the allocated sub-channel corresponding to the information about the allocated sub-channel.

In order to accomplish the above-mentioned objects, in accordance with another aspect of the present invention, there is provided a system for supporting handover in a broadband wireless access communication system. The system comprises a mobile station (MS); a serving base station (BS) which currently provides a communication service to the MS; and a target BS to which handover of the MS is directed, wherein one of the serving BS and the target BS allocates the different sub-channel as that which is allocated by the other BS to the MS in a specific time period in the same time period and at least one of the serving BS and the target BS transmits information about the allocated sub-channel to the MS, and wherein the MS receives the information about the allocated sub-channel and the serving BS and the target BS transmit a signal to the MS using the allocated sub-channel corresponding to the information about the allocated sub-channel.

In order to accomplish the above-mentioned objects, in accordance with another aspect of the present invention, there is provided a system for supporting handover in a broadband wireless access communication system. The system comprises a mobile station (MS); a serving base station (BS) which currently provides a communication service to the MS; and a target BS to which handover of the MS is directed, wherein one of the serving BS and the target BS allocates the different sub-channel as that which is allocated by the other BS to the MS in a specific time period in the different time period and at least one of the serving BS and the_target BS transmits information about the allocated sub-channel to the MS, and wherein the MS receives the information about the allocated sub-channel and the serving BS and the target BS transmit a signal to the MS using the allocated sub-channel corresponding to the information about the allocated sub-channel.

### BRIEF DESCRIPTION OF THE DRAWINGS

The above and other objects, features and advantages of the present invention will be more apparent from the following detailed description taken in conjunction with the accompanying drawings, in which:

FIG. 1 is a diagram illustrating the use of frequency resources in a broadband wireless communication system;

FIG. 2 is a diagram illustrating a scheme in which BSs allocate a sub-channel and transmits a signal based on such sub-channel allocation in accordance with a first preferred embodiment of the present invention;

FIG. 3 is a diagram illustrating a scheme in which BSs allocate a sub-channel and transmits a signal based on such sub-channel allocation in accordance with a second preferred embodiment of the present invention;

FIG. 4 is a diagram illustrating a scheme in which BSs allocate a sub-channel and transmits a signal based on such sub-channel allocation in accordance with a third preferred embodiment of the present invention;

FIG. 5 is a diagram illustrating a scheme in which an MS transmits data over an uplink using an allocated sub-channel in accordance with a fourth preferred embodiment of the present invention;

FIG. 6 is a diagram illustrating a scheme in which an MS transmits data over an uplink using an allocated sub-channel in accordance with a sixth preferred embodiment of the present invention; and

FIG. 7 is a diagram illustrating a scheme in which an MS transmits data over an uplink using an allocated sub-channel in accordance with a seventh preferred embodiment of the present invention.

### DETAILED DESCRIPTION OF THE PREFERRED EMBODIMENT

Hereinafter, preferred embodiments of the present invention will be described with reference to the accompanying drawings. It is noted that similar components are designated by similar reference numerals although they are illustrated in different drawings. Also, in the following description of the present invention, a detailed description of known functions and configurations incorporated herein will be omitted when it may make the subject matter of the present invention rather unclear.

The present invention proposes a variety of resource allocation schemes for supporting soft/softer handover of an MS in a broadband wireless access communication system employing an OFDMA scheme. To this end, BSs transmit to the MS a Downlink Map (hereinafter referred to as ‘DL-MAP’) and an Uplink Map (hereinafter referred to as ‘UL-MAP’) which contain information about sub-channel allocation, and the MS may transmit data to at least the BS according to the information about the sub-channel allocation which is recognized by receiving the DL-MAP and the UL-MAP.

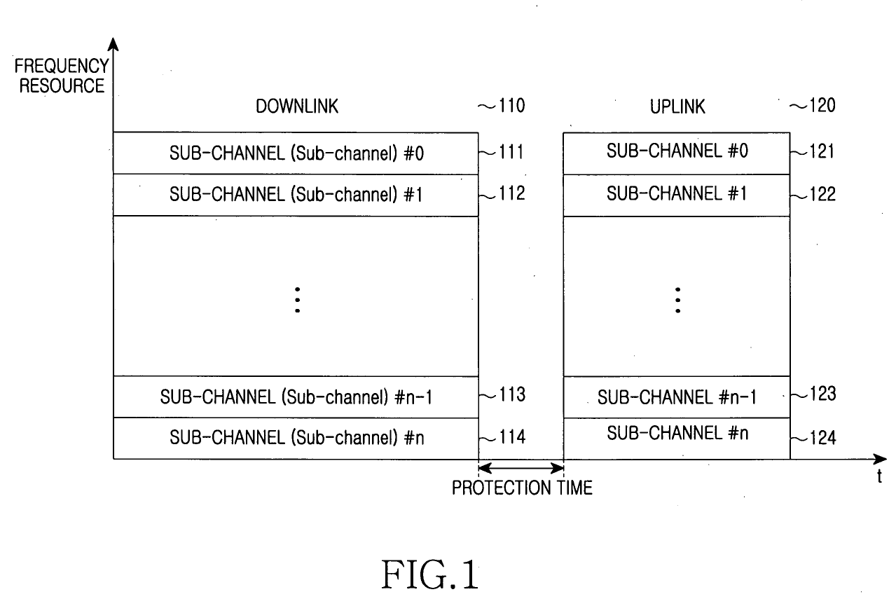

FIG. 1 is a diagram illustrating the use of frequency resources in a broadband wireless access communication system.

Referring to FIG. 1, the x-axis denotes time and the y-axis denotes the frequency resource. The frequency resource signifies a plurality of sub-channels, and the respective sub-channels consist of at least a sub-carrier.

In a downlink 110, (n+1) sub-channels 111, 112, . . . , 113, 114 exist. In an uplink 120, (n+1) sub-channels 121, 122, . . . , 123, 124 also exist. The sub-channel may consist of a plurality of adjacent sub-carriers or a plurality of non-adjacent sub-carriers. In FIG. 1, a plurality of adjacent sub-carriers constitute one sub-channel, but this is only an example to explain the construction of the sub-channel and is not meant to imply that the sub-channel must be actually constructed in that way. That is, in FIGS. 1 to 7, the sub-channel does not denote the actual physical positions of sub-carriers in a frequency band, but denotes a set of sub-carriers which are selected in a frequency band by a certain method. In the downlink and the uplink, pilot and preamble transmission periods may also exist, but this is not shown in FIG. 1.

A description will be given for a method in which a BS allocates a sub-channel to an MS in a downlink so as to support soft/softer handover of the MS and then a description will be also given for a method in which the MS transmits a signal to the BS over an uplink while maintaining at least a link corresponding to the allocated sub-channel. As stated above, the sub-channel for soft/softer handover is allocated to the MS, so that the MS can perform soft/softer handover in a handover area. Prerequisites for performing soft/softer handover will now be described.

Prerequisites

1. A coverage difference between cells or sectors must be limited to a certain range to be accommodated within a Cyclic Prefix (CP). This means that a difference in time when the BSs receive the reference signal must be within a certain time range so as to satisfy synchronization requirements. If this prerequisite is not satisfied, performance deterioration will occur during soft/softer handover.

2. The MS can estimate a channel and receive a signal from each cell or sector, in particular, must be capable of receiving all MAPs which are allocation information sent by each BS.

The sub-channel is designed such that the number of sub-carriers colliding with each other is minimized between the sub-channels used in each cell or sector by differentiating permutation according to cell-IDs or sector-Ids specifically defined on a cell by cell or sector by sector basis. In this case, various sub-channels different from each other may be defined according to the permutations of the sub-carriers.

In the present invention, each BS must perform scheduling for soft handover in consideration of the following matters. Firstly, in a case where it is possible to exchange scheduling information between the BSs in real time, the BS performs the scheduling in the most efficient way while varying a data transmission section, a modulation order, a coding rate and the like for the relevant MS from frame to frame during a handover period through the exchange of the allocation information with the BSs. Secondly, in a case where it is impossible to exchange scheduling information between the BSs, all of the BSs fix allocation information including a data transmission section, a modulation order, a coding rate and the like for the relevant MS and transmits data using the fixed allocation scheme during a handover period.

1. Method for Sub-Channel Allocation and Handover in Downlink

Prior to a description, it is noted that since the present invention relates to a sub-channel allocation method and a data transmission/reception method for supporting soft or softer handover from one cell or sector to another cell or sector, the present invention can also be applied even when cells A and B to be mentioned below are replaced by sectors A and B, respectively. Here, sectors A and B exist in the same cell.

### EXAMPLE 1

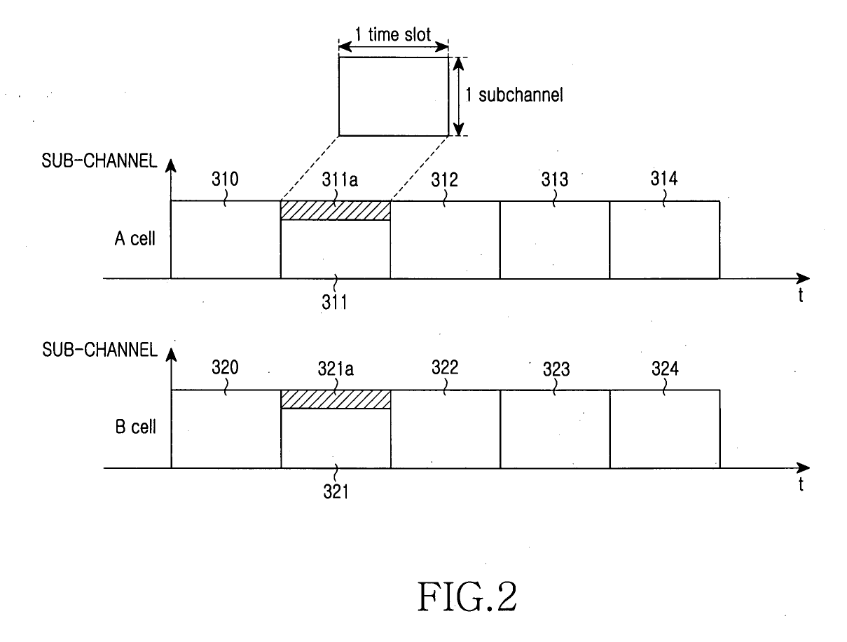

FIG. 2 illustrates a scheme in which BSs allocate a sub-channel and transmits a signal based on such sub-channel allocation in accordance with a first preferred embodiment of the present invention.

Referring to FIG. 2, a BS of cell A allocates a sub-channel 311a to an MS on handover in a specific time slot 311 form among the plurality of time slots 310, 311, 312, 313, and 314 of a downlink frame. A BS of cell B also allocates a sub-channel 321a to the MS on handover in a specific time slot 321 from among the plurality of time slots 320, 321, 322, 323, and 324 of a downlink frame. At this time, the sub-channel 311a and the sub-channel 321a are the same sub-channel in which the same sub-carriers are defined according to the same permutation rule.

The MS to which the same sub-channels have been allocated to in the same time slot receives a signal without classifying signals from the respective BSs in the same manner as when it receives a signal from one BS. That is, both the BSs of cells A and B broadcast the same allocation information (DL-MAP/UL-MAP). Thus, if the MS only has to receive the allocation information (DL-MAP/UL-MAP) from any one of the BSs of cells A and B, the MS can receive all of the signals transmitted from the BSs of cells A and B. Of course, the MS must previously recognize that the same allocation information (DL-MAP/UL-MAP) is broadcasted from the BSs. The MS can receive the allocation information from any one of the BSs of cells A and B by comparing the intensities of signals from cells A and B and selecting the stronger.

As stated above, the sub-channel allocation and signal transmission method according to the first preferred embodiment is advantageous in that latency time according to data reception is short, inter-cell interference is reduced owing to using the same sub-channel in the same time slot, a coverage hole can be diminished, and performance of channel estimation is good. Therefore, such a method can also be applied to a broadcasting service.

### EXAMPLE 2

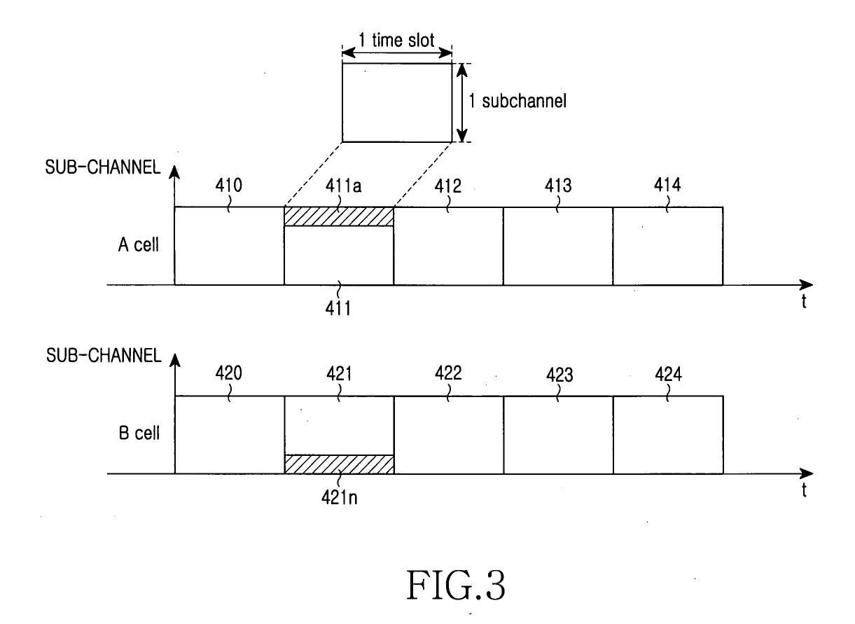

FIG. 3 illustrates a scheme in which BSs allocate a sub-channel and transmit signals based on such sub-channel allocations in accordance with a second preferred embodiment of the present invention.

Referring to FIG. 3, a BS of cell A allocates a specific sub-channel 411a to an MS on handover in a specific time slot 411 from among the plurality of time slots 410, 411, 412, 413, and 414 of a downlink frame. A BS of cell B also allocates a specific sub-channel 421n to the MS on handover in a specific time slot 421 from among the plurality of time slots 420, 421, 422, 423, and 424 of a downlink frame. The sub-channel 411a and the sub-channel 421n exist in the same time slot, but are different sub-channels from each other. Here, a different sub-channel signifies a sub-channel which is constructed by a different subchannelization method or consists of different sub-carriers.

Thus, the MS must receive all of the allocation information (DL-MAP/UL-MAP) transmitted from the BSs of cells A and B until it has sufficient information to determine the positions of the sub-channels 411a and 421n and receive data.

As stated above, since the method in accordance with the second preferred embodiment employs a scheme in which data is transmitted in the same time slot, it has an advantage of short latency time as in the first embodiment. Moreover, its performance is improved due to the frequency diversity.

The allocation information (DL-MAP/UL-MAP) of the BSs of cells A and B may be separately transmitted according to the respective BSs, a serving BS may transmit all of the allocation information (DL-MAP/UL-MAP) of all of the BSs, or all of the BSs may simultaneously transmit all of the allocation information (DL-MAP/UL-MAP) of their own. The MS is aware of any one of the above-mentioned various transmitting methods of the allocation information in advance and so can receive data in a handover area.

### EXAMPLE 3

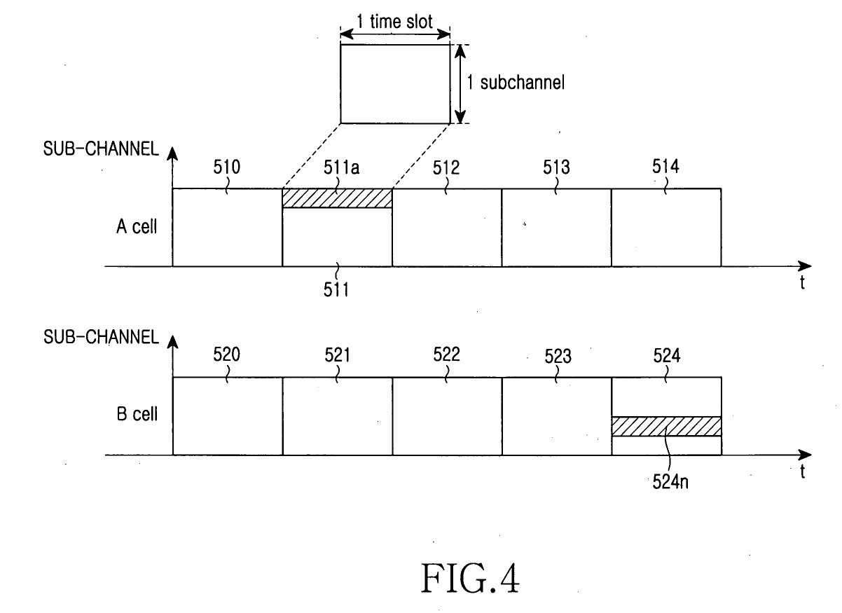

FIG. 4 illustrates a scheme in which BSs allocate a sub-channel and transmit a signal based on such sub-channel allocation in accordance with a third preferred embodiment of the present invention.

Referring to FIG. 4, a BS of cell A allocates a sub-channel 511a to an MS in a specific time slot 511 from among the plurality of time slots 510, 511, 512, 513, and 514 of a downlink frame. A BS of cell B also allocates a sub-channel 524n to the MS in a specific time slot 524 from among the plurality of time slots 520, 521, 522, 523, and 524 of a downlink frame. At this time, the time slot 511 in cell A and the time slot 524 in cell B can be different time slots from each other. Also, the sub-channel 511a and the sub-channel 524n allocated to the MS are sub-channels having different frequency resources from each other.

In this way, according to the third preferred embodiment, the MS receives signals from different BSs or sectors through different time slots and on different sub-channels. Since different BSs do not have to transmit data to be transmitted to the MS, which is located in a handover area, in the same time slots, the scheduling of each BS has more flexibility and the necessity for rapid message delivery between a BS and a Base Station Controller (BSC) disappears. Here, the MS must be capable of receiving all the allocation information (DL-MAP/UL-MAP) transmitted from the respective BSs.

2. Handover Method in Uplink According to Sub-Channel Allocation

In a case of soft handover in an uplink, a BSC selects a signal received from at least two BSs to acquire a selection diversity gain. In softer handover, the BS combines two signals received from both sectors.

### EXAMPLE 4

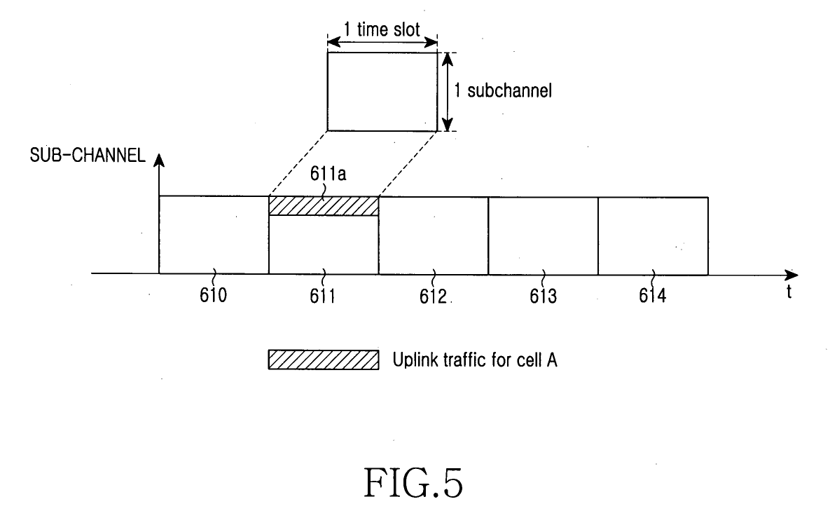

FIG. 5 illustrates a scheme in which an MS transmits data over an uplink using an allocated sub-channel in accordance with a fourth preferred embodiment of the present invention.

Referring to FIG. 5, the MS performs uplink data transmission using a sub-channel 611a which is allocated in a time slot 611 indicated by an UL-MAP including uplink sub-channel allocation information from among the plurality of time slots 610, 611, 612, 613, and 614 to be transmitted over an uplink. This fourth preferred embodiment assumes that the same sub-channels are allocated to the MS from at least two BSs. Thus, the uplink signal transmitted from the MS can be received by all of the BSs.

In this way, the BSs must transmit the same UL-MAPs to the MS in order to receive signals from the MS. The MS may receive all of the UL-MAPs from the BSs or may receive only one UL-MAP having a greater signal intensity to acquire allocation information about itself.

### EXAMPLE 5

In a case where BSs use different subchannelization methods from each other, an MS located in a handover area transmits a signal using a sub-channel which a serving BS allocates to the MS. The transmitted signal may be received by a target BS to which handover of the MS is directed as well as the serving BS.

This fifth preferred embodiment is advantageous in that the use of resources is minimized and latency time is short. However, the performance of the reception in a target cell or sector may deteriorate due to the collision of the sub-carriers with other sub-channels within the target cell.

### EXAMPLE 6

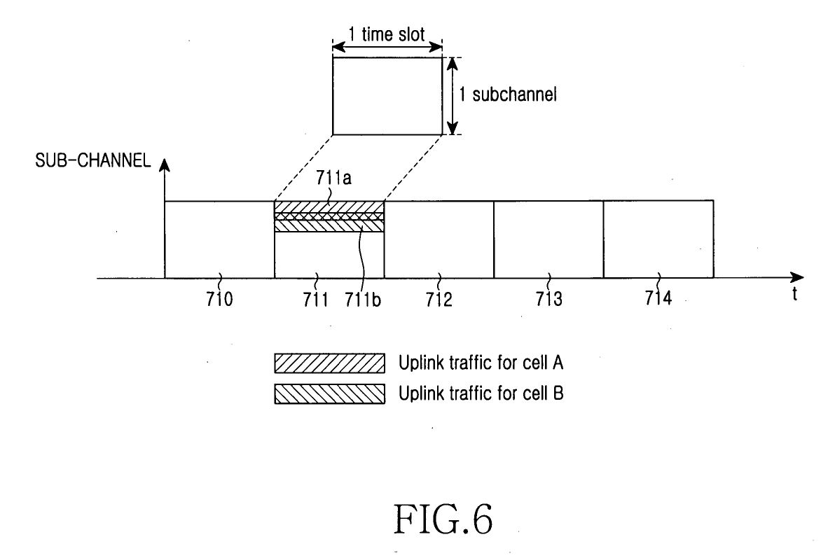

FIG. 6 illustrates a scheme in which an MS transmits data over an uplink using an allocated sub-channel in accordance with a sixth preferred embodiment of the present invention.

Referring to FIG. 6, the MS on handover performs uplink data transmission using a sub-channel 711a which is allocated in a time slot 711 indicated by an UL-MAP of a serving BS from among the plurality of time slots 710, 711, 712, 713, and 714 to be transmitted over an uplink, and simultaneously performs uplink data transmission using a sub-channel 711b which is allocated in a time slot 711 indicated by an UL-MAP of a target BS.

The MS simultaneously transmits the same data to two BSs or sectors using a sub-channel allocated from a serving cell or sector and a sub-channel allocated from a target cell or sector. Thus, the two BSs or sectors receive signals to register them in a BSC or a BS.

In the method in accordance with this sixth preferred embodiment, short latency time and improvement in performance due to frequency diversity may be expected because data is transmitted in the same time slots. However, in soft handover, rapid message delivery between the BCS and the BS will be required when time slots or sub-channels are changed in a short time unit.

### EXAMPLE 7

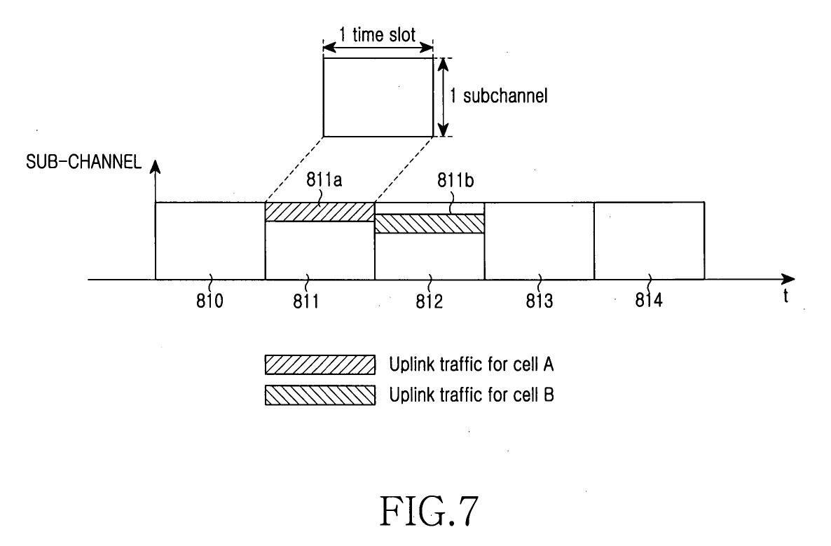

FIG. 7 illustrates a scheme in which an MS transmits data over an uplink using an allocated sub-channel in accordance with a seventh preferred embodiment of the present invention.

Referring to FIG. 7, the MS performs uplink data transmission using a sub-channel 811a which is allocated in a time slot 811 indicated by an UL-MAP of a serving BS from among the plurality of time slots 810, 811, 812, 813, and 814 to be transmitted over an uplink. The MS also performs uplink data transmission using a sub-channel 811b which is allocated in a time slot 812 indicated by an UL-MAP of a target BS.

In this way, the MS transmits data over an uplink using sub-channels which are allocated in different time slots by two BSs or sectors. That is, the serving BS and the target BS determine the time slots and the sub-channels in which the MS can transmit data. Thus, the BSs are previously aware of the points in time at which data will be received and so the respective BSs do not need to set points of time for transmission.

In the method according to this seventh preferred embodiment, since the MS does not have to transmit data to the two BSs in the same time slots, the scheduling of each BS has more flexibility and any necessity for rapid message delivery between a BS and a BSC disappears.

A description will be given for signal transmission/reception procedures between an MS, a serving BS and a target BS in a downlink and signal transmission/reception procedures between the MS, the serving BS and the target BS in an uplink with reference to the above-mentioned embodiments.

In the downlink the serving BS may transmit only its own DL-MAP or may also transmit a DL-MAP of the target BS, to which handover of the MS is directed. Similarly, the target BS may transmit only its own DL-MAP or may also transmit a DL-MAP of the serving BS.

In the downlink the MS may receive only the DL-MAP of the serving BS, may receive only the DL-Map of any one BS, a reception condition of which is better than the other, or may receive the DL-MAPs of all of the BSs, corresponding with the DL-MAP transmission schemes of the serving BS and the target BS. For example, the serving BS and the target BS may transmit the same DL-MAPs. In this case, the MS can become aware of all of the sub-channel allocation information of the serving BS and the target BS by receiving only the DL-MAP of the serving BS or only the DL-MAP favorably received. However, when the serving BS and the target BS transmit different DL-MAPs from each other, the MS may receive downlink signals from the serving BS and the target BS by receiving the DL-MAPs of both of the BSs.

In the uplink the serving BS may transmit only its own UL-MAP or may also transmit a UL-MAP of the target BS, to which handover of the MS is directed. Similarly, the target BS may transmit only its own UL-MAP or may also transmit a UL-MAP of the serving BS.

In the uplink the MS may receive only the UL-MAP of the serving BS, may receive only the UL-MAP of any one BS, a reception condition of which is better than the other, or may receive the UL-MAPs of all of the BSs, corresponding with the UL-MAP transmission schemes of the serving BS and the target BS. For example, the serving BS and the target BS may transmit the same UL-MAPs. In this case, the MS can become aware of all of the sub-channel allocation information of the serving BS and the target BS by receiving only the UL-MAP of the serving BS or only the UL-MAP favorably received. However, when the serving BS and the target BS transmit different UL-MAPs from each other, the MS may receive downlink signals from the serving BS and the target BS by receiving the UL-MAPs of both the BSs.

As described above, the present invention provides various methods for sub-channel allocation and data transmission/reception based on such sub-channel allocation in order to support soft and softer handovers of an MS in a broadband wireless access communication system, thereby improving performance of a user terminal located in the border of a cell and reducing signal interference with other cells. Also, it is possible to support handover without disconnection in the 4G (4^{th} generation) communication system.

While the invention has been shown and described with reference to certain preferred embodiments thereof, it will be understood by those skilled in the art that various changes in form and details may be made therein without departing from the spirit and scope of the invention as defined by the appended claims.

1. A method for supporting a serving base station (BS) currently providing a mobile station (MS) with a communication service to perform a handover in a broadband wireless access communication system which includes the MS, the serving BS and a target BS to which handover of the MS is directed, the method comprising the steps of:
allowing one of the serving BS and the target BS to allocate the same sub-channel as that which is allocated by the other BS to the MS in a specific time period in the same time period; and
transmitting information about the allocated sub-channel to the MS.

2. The method as claimed in claim 1, wherein at least one of the serving BS and the target BS transmits sub-channel allocation information of at least one of the serving BS and the target BS to the MS.

3. The method as claimed in claim 2, wherein the sub-channel allocation information of the respective BSs is included in at least one of a UL-MAP and a DL-MAP of the respective BSs.

4. A method for supporting a serving base station (BS) currently providing a mobile station (MS) with a communication service to perform a handover in a broadband wireless access communication system which includes the MS, the serving BS and a target BS to which handover of the MS is directed, the method comprising the steps of:
allowing one of the serving BS and the target BS to allocate a different sub-channel from that which is allocated by the other BS to the MS in a specific time period in the same specific time period; and
transmitting information about the allocated sub-channel to the MS.

5. The method as claimed in claim 5, wherein at least one of the serving BS and the target BS transmits sub-channel allocation information of the serving BS and the target BS to the MS.

6. The method as claimed in claim 5, wherein the serving BS and the target BS transmit their own sub-channel allocation information to the MS.

7. The method as claimed in claim 5, wherein the sub-channel allocation information of the respective BSs is included in at least one of a UL-MAP and a DL-MAP of the respective BSs.

8. The method as claimed in claim 6, wherein the sub-channel allocation information of the respective BSs is included in at least one of a UL-MAP and a DL-MAP of the respective BSs.

9. A method for supporting a serving base station (BS) currently providing a mobile station (MS) with a communication service to perform a handover in a broadband wireless access communication system which includes the MS, the serving BS and a target BS to which handover of the MS is directed, the method comprising the steps of:
allowing one of the serving BS and the target BS to allocate a different sub-channel from that which is allocated by the other BS to the MS in a specific time period in a different time period; and
transmitting information about the allocated sub-channel to the MS.

10. The method as claimed in claim 9, wherein at least one of the serving BS and the target BS transmits sub-channel allocation information of the serving BS and the target BS to the MS.

11. The method as claimed in claim 9, wherein the serving BS and the target BS transmit their own sub-channel allocation information to the MS.

12. The method as claimed in claim 10, wherein the sub-channel allocation information of the respective BSs is included in at least one of a UL-MAP and a DL-MAP of the respective BSs.

13. The method as claimed in claim 11, wherein the sub-channel allocation information of the respective BSs is included in at least one of a UL-MAP and a DL-MAP of the respective BSs.

14. A method for transmitting a signal by an MS in order to perform a handover in a broadband wireless access communication system which includes the MS, a serving BS currently providing the MS with a communication service and a target BS to which handover of the MS is directed, the method comprising the steps of:
receiving information about sub-channel allocation of the serving BS and information about sub-channel allocation of the target BS from at least one of the serving BS and the target BS; and
transmitting the signal to the serving BS and the target BS using the allocated sub-channel corresponding to the information about sub-channel allocation.

15. The method as claimed in claim 14, wherein the sub-channel allocation information of the respective BSs is included in at least one of UL-MAPs and DL-MAPs of the respective BSs.

16. The method as claimed in claim 14, wherein, when the same sub-channels are allocated in the same time slots, the MS receives the sub-channel allocation information of the serving BS and the sub-channel allocation information of the target BS from at least one of the serving BS and the target BS.

17. The method as claimed in claim 14, wherein, when the same sub-channels are allocated in the same time slots, the MS receives the sub-channel allocation information of the serving BS and the sub-channel allocation information of the target BS from one BS, a channel condition of which is better than the other, of the serving BS and the target BS.

18. The method as claimed in claim 14, wherein when the sub-channel allocated by the serving BS and the sub-channel allocated by the target BS are different from each other, the MS receives the sub-channel information of the serving BS and the sub-channel information of the target BS from the respective BSs.

19. The method as claimed in claim 14, wherein, when the sub-channel allocated by the serving BS and the sub-channel allocated by the target BS are different from each other, the MS receives the sub-channel information of the BSs from at least one of the serving BS and the target BS.

20. A system for supporting handover in a broadband wireless access communication system, the system comprising:
a mobile station (MS);
a serving base station (BS) which currently provides a communication service to the MS; and
a target BS to which handover of the MS is directed, wherein one of the serving BS and the target BS allocates the same sub-channel as that which is allocated by the other BS to the MS in a specific time period in the same time period and at least one of the serving BS and the target BS transmits information about the allocated sub-channel to the MS, and wherein the MS receives the information about the allocated sub-channel and transmits a signal to the serving BS and the target BS using the allocated sub-channel corresponding to the information about the allocated sub-channel.

21. The system as claimed in claim 20, wherein the serving BS transmits sub-channel allocation information of the target BS together with its own sub-channel allocation information.

22. The system as claimed in claim 20, wherein the target BS transmits sub-channel allocation information of the serving BS together with its own sub-channel allocation information.

23. The system as claimed in claim 20, wherein, when the same sub-channels are allocated in the same time slots, the MS receives the sub-channel allocation information of the serving BS and the sub-channel allocation information of the target BS from at least one of the serving BS and the target BS.

24. The system as claimed in claim 20, wherein, when the same sub-channels are allocated in the same time slots, the MS receives the sub-channel allocation information of the serving BS and the sub-channel allocation information of the target BS from one BS, a channel condition of which is better than the other, of the serving BS and the target BS.

25. A system for supporting handover in a broadband wireless access communication system, the system comprising:
a mobile station (MS);
a serving base station (BS) which currently provides a communication service to the MS; and
a target BS to which handover of the MS is directed,
wherein one of the serving BS and the target BS allocates the different sub-channel as that which is allocated by the other BS to the MS in a specific time period in the same time period and at least one of the serving BS and the target_BS transmits information about the allocated sub-channel to the MS, and wherein the MS receives the information about the allocated sub-channel and transmits a signal to the serving BS and the target BS using the allocated sub-channel corresponding to the information about the allocated sub-channel.

26. The system as claimed in claim 25, wherein the MS receives the sub-channel information of the serving BS and the sub-channel information of the target BS from the respective BSs.

27. The system as claimed in claim 25, wherein the MS receives the sub-channel information of the BSs from at least one of the serving BS and the target BS.

28. A system for supporting handover in a broadband wireless access communication system, the system comprising:
a mobile station (MS);
a serving base station (BS) which currently provides a communication service to the MS; and
a target BS to which handover of the MS is directed,
wherein one of the serving BS and the target BS allocates the different sub-channel as that which is allocated by the other BS to the MS in a specific time period in the different time period and at least one of the serving BS and the target BS transmits information about the allocated sub-channel to the MS, and wherein the MS receives the information about the allocated sub-channel and transmits a signal to the serving BS and the target BS using the allocated sub-channel corresponding to the information about the allocated sub-channel.

29. The system as claimed in claim 28, wherein the MS receives the sub-channel information of the serving BS and the sub-channel information of the target BS from the respective BSs.

30. The system as claimed in claim 28, wherein the MS receives the sub-channel information of the BSs from at least one of the serving BS and the target BS.

31. A method for transmitting a signal by an BS in order to perform a handover in a broadband wireless access communication system which includes the MS, a serving BS currently providing the MS with a communication service and a target BS to which handover of the MS is directed, the method comprising the steps of:
receiving information about sub-channel allocation of the serving BS and information about sub-channel allocation of the target BS from at least one of the serving BS and the target BS; and
transmitting the signal to the MS using the allocated sub-channel corresponding to the information about sub-channel allocation.

32. The method as claimed in claim 31, wherein the sub-channel allocation information of the respective BSs is included in at least one of UL-MAPs and DL-MAPs of the respective BSs.

33. The method as claimed in claim 31, wherein, when the same sub-channels are allocated in the same time slots, the MS receives the sub-channel allocation information of the serving BS and the sub-channel allocation information of the target BS from at least one of the serving BS and the target BS.

34. The method as claimed in claim 31, wherein, when the same sub-channels are allocated in the same time slots, the MS receives the sub-channel allocation information of the serving BS and the sub-channel allocation information of the target BS from one BS, a channel condition of which is better than the other, of the serving BS and the target BS.

35. The method as claimed in claim 31, wherein when the sub-channel allocated by the serving BS and the sub-channel allocated by the target BS are different from each other, the MS receives the sub-channel information of the serving BS and the sub-channel information of the target BS from the respective BSs.

36. The method as claimed in claim 31, wherein, when the sub-channel allocated by the serving BS and the sub-channel allocated by the target BS are different from each other, the MS receives the sub-channel information of the BSs from at least one of the serving BS and the target BS.

37. A system for supporting handover in a broadband wireless access communication system, the system comprising:
a mobile station (MS);
a serving base station (BS) which currently provides a communication service to the MS; and
a target BS to which handover of the MS is directed,
wherein one of the serving BS and the target BS allocates the same sub-channel as that which is allocated by the other BS to the MS in a specific time period in the same time period and at least one of the serving BS and the target BS transmits information about the allocated sub-channel to the MS, and wherein the MS receives the information about the allocated sub-channel and the serving BS and the target BS transmit a signal to the MS using the allocated sub-channel corresponding to the information about the allocated sub-channel.

38. The system as claimed in claim 37, wherein the serving BS transmits sub-channel allocation information of the target BS together with its own sub-channel allocation information.

39. The system as claimed in claim 37, wherein the target BS transmits sub-channel allocation information of the serving BS together with its own sub-channel allocation information.

40. The system as claimed in claim 37, wherein, when the same sub-channels are allocated in the same time slots, the MS receives the sub-channel allocation information of the serving BS and the sub-channel allocation information of the target BS from at least one of the serving BS and the target BS.

41. The system as claimed in claim 37, wherein, when the same sub-channels are allocated in the same time slots, the MS receives the sub-channel allocation information of the serving BS and the sub-channel allocation information of the target BS from one BS, a channel condition of which is better than the other, of the serving BS and the target BS.

42. A system for supporting handover in a broadband wireless access communication system, the system comprising:
a mobile station (MS);
a serving base station (BS) which currently provides a communication service to the MS; and
a target BS to which handover of the MS is directed,
wherein one of the serving BS and the target BS allocates the different sub-channel as that which is allocated by the other BS to the MS in a specific time period in the same time period and at least one of the serving BS and the target BS transmits information about the allocated sub-channel to the MS, and wherein the MS receives the information about the allocated sub-channel and the serving BS and the target BS transmit a signal to the MS using the allocated sub-channel corresponding to the information about the allocated sub-channel.

43. The system as claimed in claim 42, wherein the MS receives the sub-channel information of the serving BS and the sub-channel information of the target BS from the respective BSs.

44. The system as claimed in claim 42, wherein the MS receives the sub-channel information of the BSs from at least one of the serving BS and the target BS.

45. A system for supporting handover in a broadband wireless access communication system, the system comprising:
a mobile station (MS);
a serving base station (BS) which currently provides a communication service to the MS; and
a target BS to which handover of the MS is directed,
wherein one of the serving BS and the target BS allocates the different sub-channel as that which is allocated by the other BS to the MS in a specific time period in the different time period and at least one of the serving BS and the target BS transmits information about the allocated sub-channel to the MS, and wherein the MS receives the information about the allocated sub-channel and the serving BS and the target BS transmit a signal to the MS using the allocated sub-channel corresponding to the information about the allocated sub-channel.

46. The system as claimed in claim 45, wherein the MS receives the sub-channel information of the serving BS and the sub-channel information of the target BS from the respective BSs.

47. The system as claimed in claim 45, wherein the MS receives the sub-channel information of the BSs from at least one of the serving BS and the target BS.
